(19) United States
(12) Patent Application Publication
(10) Pub. No.: US 2022/0133083 A1
(43) Pub. Date: May 5, 2022

(54) COOKING CONTAINER LID HAVING AUXILIARY LID

(71) Applicant: HONG SAN LIGHT METAL CO., LTD., Busan (KR)

(72) Inventor: Gyung Chan SEO, Busan (KR)

(73) Assignee: HONG SAN LIGHT METAL CO., LTD., Busan (KR)

(21) Appl. No.: 17/606,113

(22) PCT Filed: Sep. 8, 2020
(86) PCT No.: PCT/KR2020/012083

§ 371 Date: Oct. 25, 2021

(30) Foreign Application Priority Data
Sep. 20, 2019 (KR) 10-2019-0115913

(51) Int. Cl. A47J 36/06; A47J 45/07; A47J 36/04

(52) U.S. Cl. CPC A47J 36/06; A47J 36/04; A47J 45/074

(57) ABSTRACT

A cooking container lid having an auxiliary lid includes a lid body, a support and a fixing member. The lid body is formed of a glass material and divided into a main lid and an auxiliary lid. The support is configured to support the main lid and forms a through-hole, and the through-hole is opened and closed by the auxiliary lid. The fixing member fixes the support to the main lid. An opening portion of the cooking container is entirely opened when the main lid is opened, and a part of the opening portion of the cooking container is opened when the auxiliary lid is opened. The cooking container lid exhibits the effect of improving cooking convenience by providing the auxiliary lid while overcoming the disadvantages of the glass material through a structural improvement of the main lid and the through-hole.

### TECHNICAL FIELD

The present invention relates to a cooking container lid having an auxiliary lid. More particularly, the present invention relates to a cooking container lid having an auxiliary lid, in which the lid is formed of a glass material through which an inside of the cooking container can be seen and disadvantages of the glass material are overcome through structural improvements, and in which the lid is provided with the auxiliary lid, thereby increasing convenience of cooking.

### BACKGROUND

In general, lids for cooking containers are commonly used to seal opening portions of cooking containers (pots, frying pans, and the like) so as to prevent foods from overflowing and to reduce cooking time. Such a lid is usually formed of a glass material and a metal material. In recent years, the lid has been provided in various shapes with added functionality beyond a simple concept of a lid. Among the lids, a lid having a shape for preventing food materials from overflowing and in which an auxiliary lid is provided so that the auxiliary lid is capable of being frequently opened and closed during cooking so that condiments or food materials can be added is common.

As an example, a lid for a cooking vessel having a stirring function disclosed in Korean Patent No. 10-1971833 (published on Apr. 23, 2019) has been proposed. Referring to the publication described above, the lid has a stirring function by being provided with an operating means, and the lid has an auxiliary lid, so that there is an advantage that food materials or condiments may be frequently added during a cooking process. Referring to the lid of the publication described above, a hole having a predetermined size is penetratingly formed, and the auxiliary lid capable of covering the hole is provided. There is a disadvantage that this process can only be performed on a lid formed of a metal material. When the hole is formed in a lid formed of a glass material, although it will vary depending on a size of the hole, it may cause problems in that a surrounding portion where the hole is formed is weakened and becomes fragile and so on. Accordingly, it has been significantly difficult to provide the auxiliary lid to the lid formed of the glass material.

### SUMMARY

### Technical Problem

Accordingly, the present invention has been made keeping in mind the above problems occurring in the related art, and the present invention is intended to propose a cooking container lid having an auxiliary lid, in which the lid is formed of a glass material through which an inside of the cooking container can be seen and disadvantages of the glass material are overcome through structural improvements, and in which the lid is provided with the auxiliary lid, thereby increasing cooking convenience.

### Technical Solution

In order to achieve the above objective, according to one aspect of the present invention, there is provided a cooking container lid having an auxiliary lid, the cooking container lid including: a lid body formed of a glass material and divided into a main lid and an auxiliary lid; a support configured to support the main lid and forming a through-hole that is opened and closed by the auxiliary lid; and a fixing member fixing the support to the main lid, wherein an entire opening portion of the cooking container is opened when the main lid is opened, and a part of the opening portion of the cooking container is opened when the auxiliary lid is opened.

Preferably, each of the main lid and the auxiliary lid may be provided with a mounting hole in which a handle is capable of being mounted.

Preferably, the fixing member may be configured to surround both a border of the main lid and the support so that the main lid is securely supported.

Preferably, an inner wall of the through-hole may be provided with a seating jaw that is configured to allow the auxiliary lid to be stably seated on the seating jaw and to increase a sealing capacity.

Preferably, a border of the auxiliary lid may be provided with a packing so as to further increase a sealing capacity.

### Advantageous Effects

According to the present invention, although the lid is formed of the glass material through which the inside of the cooking container can be seen, disadvantages of the glass material are overcome through structural improvements. That is, the lid is divided into the main lid and the auxiliary lid, the support is provided at the main lid, and the through-hole that is opened and closed by the auxiliary lid is formed. Therefore, convenience of cooking is increased.

### BRIEF DESCRIPTION OF THE DRAWINGS

FIG. 1 is a perspective view illustrating a cooking container lid having an auxiliary lid according to an exemplary embodiment of the present invention.

FIG. 2 is a longitudinal sectional view illustrating the cooking container lid having the auxiliary lid according to an exemplary embodiment of the present invention.

FIG. 3 is a perspective view illustrating a lid body according to an exemplary embodiment of the present invention.

FIG. 4A is a perspective view illustrating a support according to an exemplary embodiment of the present invention, and FIG. 4B is a perspective view illustrating a fastening state of the support.

FIGS. 5A to 5D are views illustrating the support according to another embodiment of the present invention.

FIG. 6A is a perspective view illustrating a fixing member according to an exemplary embodiment of the present invention, and FIG. 6B is a longitudinal sectional view schematically illustrating an usage state of the fixing member.

FIG. 7 is a schematic view illustrating a process of mounting and fixing the support according to an exemplary embodiment of the present invention.

FIG. 8A is a longitudinal sectional view illustrating the support according to still another embodiment of the present invention, and FIG. 8B is a longitudinal sectional view illustrating a coupling relation of the support according to the still another embodiment of the present invention.

FIG. 9 is a longitudinal sectional view schematically illustrating an usage state of the cooking container lid according to an exemplary embodiment of the present invention.

### DETAIL DESCRIPTION OF THE EMBODIMENTS

Hereinafter, a cooking container lid having an auxiliary lid of the present invention will be described in detail with reference to the accompanying drawings.

Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

Therefore, the description proposed herein is just a preferable example for the purpose of illustrations only, not intended to limit the scope of the present invention, so it should be understood that other equivalents and modifications could be made thereto without departing from the scope of the present invention.

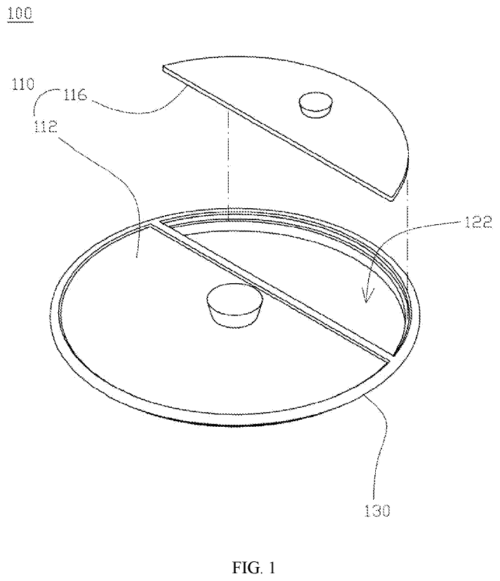

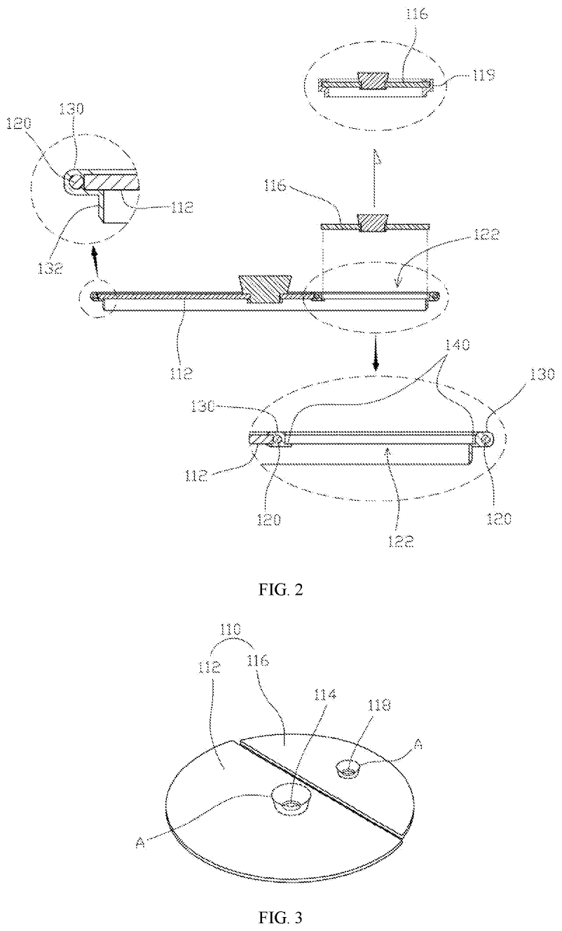

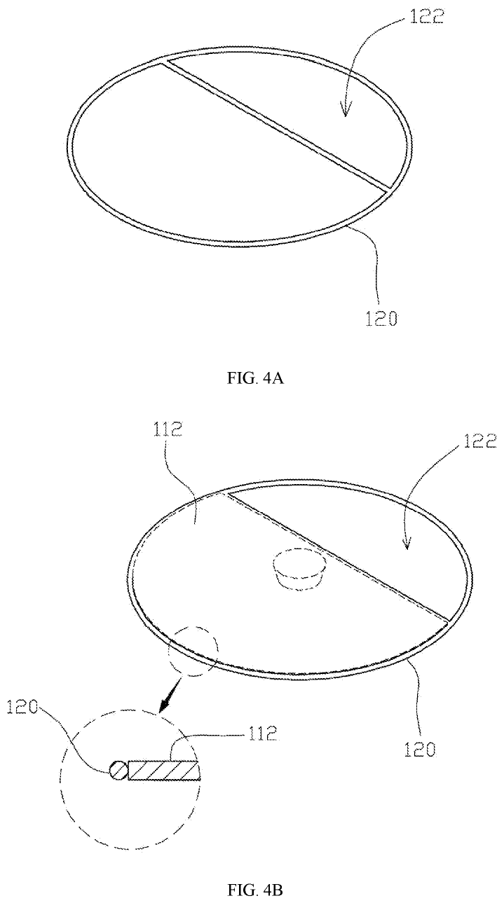

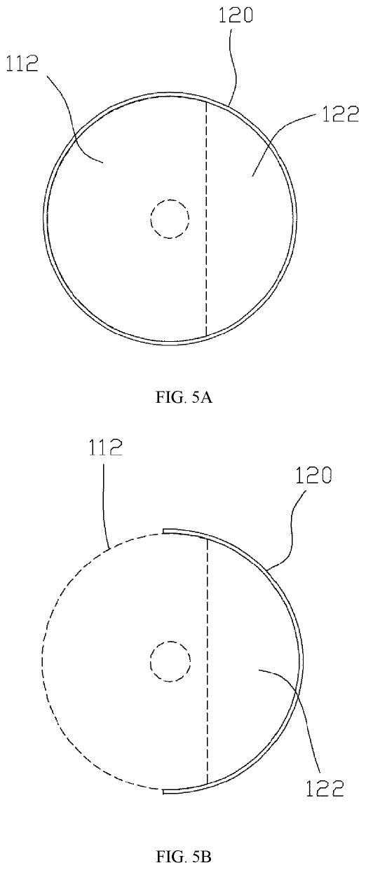

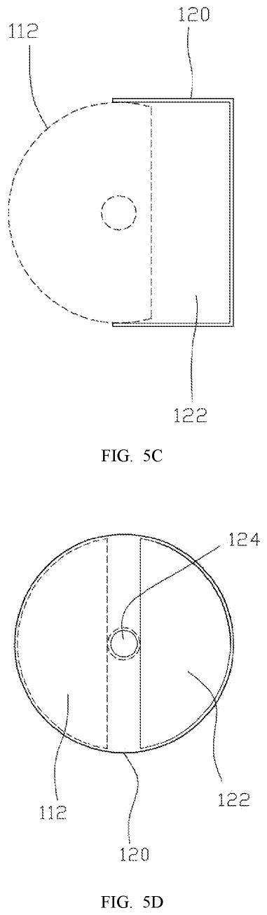

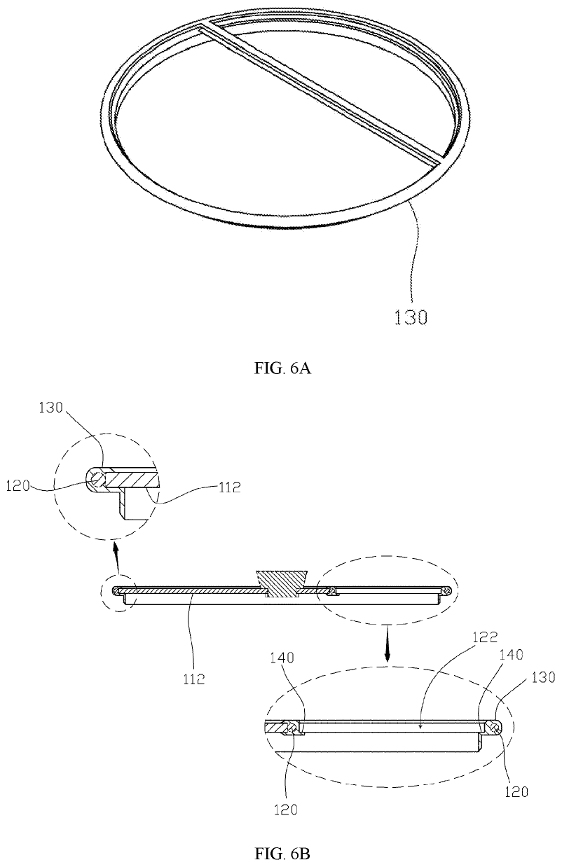

FIG. 1 is a perspective view illustrating a cooking container lid having an auxiliary lid according to an exemplary embodiment of the present invention. FIG. 2 is a longitudinal sectional view illustrating the cooking container lid having the auxiliary lid according to an exemplary embodiment of the present invention. FIG. 3 is a perspective view illustrating a lid body according to an exemplary embodiment of the present invention. FIG. 4A is a perspective view illustrating a support according to an exemplary embodiment of the present invention, and FIG. 4B is a perspective view illustrating a fastening state of the support. FIGS. 5A to 5D are views illustrating the support according to another embodiment of the present invention. FIG. 6A is a perspective view illustrating a fixing member according to an exemplary embodiment of the present invention, and FIG. 6B is a longitudinal sectional view schematically illustrating an usage state of the fixing member.

Referring to FIGS. 1 and 2, a cooking container lid 100 having an auxiliary lid of the present invention includes a lid body 110, a support 120, and a fixing member 130.

First, the lid body 110 is formed of a glass material, and is divided into a main lid 112 and an auxiliary lid 116 as illustrated in FIGS. 1 and 2. Meanwhile, the present invention proposes the lid body 110 formed of the glass material that is difficult to produce but has an advantage in that the inside of the cooking container can be seen through the lid body 110 formed of the glass material during a cooking process, and it is clear that a lid formed of a metal material that is easy to produce is not proposed in the present invention. Although there are advantages that the inside of the glass material can be observed and a washing process can be easily performed, the glass material has not been used in various shapes compared to the metal material since there is a limitation of processing due to problems such as breakage and the like. Particularly, in the glass material, a function that allows the auxiliary lid 116 to be provided at the lid body 110 may have been unable to be added. However, through structural improvements, the present invention overcomes the disadvantages described above.

At this time, it is self-evident that the lid body 110 may have a circular plate shape, a rectangular plate shape, or a dome shape, and one of the shapes is divided into the main lid 112 and the auxiliary lid 116. Further, a size of each of the main lid 112 and the auxiliary lid 116 that are divided is not limited, but it is preferable that the size of the auxiliary lid 116 is formed to be smaller than the size of the main lid 112. This is because the auxiliary lid 116 is literally provided to be used as an auxiliary, and is not necessarily formed to be larger than the main lid 112. In the main lid 112 and the auxiliary lid 116, mounting holes 114 and 118 are formed, respectively, so that respective handles (A) that facilitate an opening and closing function are allowed to be fastened thereto. Meanwhile, it is obvious that an operating means in which a device that allows a rotating operation while functioning as a handle and is mentioned in the related art (see Korean Patent No. 10-1971833) may be mounted in the mounting hole 114 formed in the main lid 112. In addition, in order to increase a sealing capacity, it is recommended that a packing 119 is provided at a border of the auxiliary lid 116.

As illustrated in FIG. 2 and FIGS. 4A and 4B, the support 120 is configured to support the main lid 112 and forms a through-hole 122 having a predetermined size, and the through-hole 122 is opened and closed by the auxiliary lid 116 positioned at a first side of the main lid 112. It is most preferable that the support 120 is formed in a type having a shape that performs supporting by surrounding along a side surface of a border of the main lid 112 so as to securely perform supporting while the through-hole 122 that is to be opened and closed by the auxiliary lid 116 is formed at the first side of the main lid 112.

However, the shape is not limited thereto. Further, as illustrated FIGS. 5A to 5D, a simple “O”-shape, a “C”-shape, or a “U”-shape may be applied as the shape of the support 120. Furthermore, as illustrated in FIG. 5D, it should be noted that a type in which a handle fastening hole 124 is formed in a center of the support 120 is applicable. As a result, it is sufficient that the support 120 has a type forming the through-hole 122 that is capable of being opened and closed by the auxiliary lid 116 while the support 120 supports a first end of the main lid 112. Further, it is preferable that the support 120 is formed of a metal wire that is rigid, but may be formed of a synthetic resin material that is rigid and heat-resistive.

Next, the fixing member 130 is provided to fix the support 120 to the main lid 112, and a material of the fixing member 130 is not limited, but it is preferable that the fixing member 130 is formed of a silicone material that has an excellent adhesion and is harmless to a human body. That is, as illustrated in FIGS. 6A and 6B, the main lid 112 and the support 120 are fastened to each other by forming the support 120 to completely surround the border of the main lid 112. Accordingly, when the silicone material that will be the fixing member 130 is applied along the border of the main lid 112, the silicone material is hardened, and the fixing member 130 securely fastens the support 120. Meanwhile, it is preferable that a seating jaw 140 is formed at an inner wall of the through-hole 122 that is formed by the support 120 so as to allow the auxiliary lid 116 to be stably supported on the seating jaw 140 and to increase the sealing capacity. Of course, when the seating jaw 140 is formed, the seating jaw 140 may be formed via the fixing member 130, but may be formed at the support 120. Next, it is preferable that a protruding portion 132 that protrudes downward is formed at a bottom surface of the fixing member 130 so that the lid body 110 is stably coupled to the container and has the excellent sealing capacity when the protruding portion 132 covers the lid body 110.

The fixing member 130 is provided to fix the support 120 to the main lid 112. As illustrated in drawings, the fixing member 130 does not need to be formed to completely surround the support 120, and may be formed such that the fixing member 130 is applied only a portion of the support 120 depending on a condition.

Hereinafter, a process of mounting and fixing of the support having the configuration as described above will be described in detail.

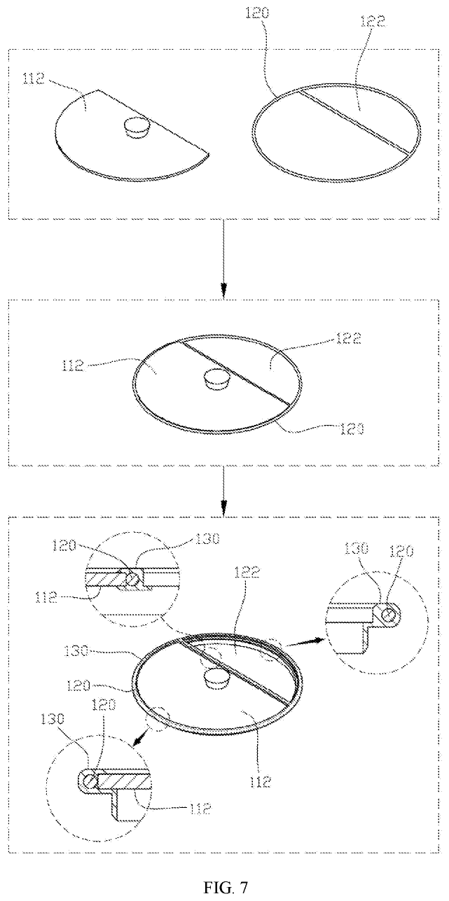

FIG. 7 is a schematic view illustrating a process of mounting and fixing the support according to an exemplary embodiment of the present invention.

Referring to FIG. 7, the main lid 112 is mounted on the support 120 such that the first end of the support 120 supports the main lid 112, and then the support 120 is fixed by the fixing member 130 that is formed by applying the silicone material along the border of the main lid 112. At this time, when the silicone material that will be the fixing member 130 is applied, it is obvious that a mold frame that is manufactured to fit the shape is used, as widely known.

As the fixing member 130 completely surrounds the support 120 and is formed along the border of the main lid 112, it is obvious that the fixing member 130 securely fixes the support 120. At this time, when the silicone material is applied, it is preferable that the seating jaw 140 is formed at the inner wall of the through-hole 122 that is formed by the support 120.

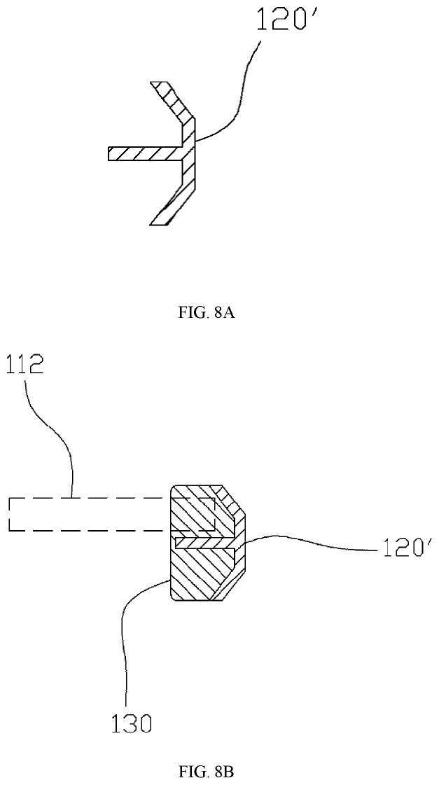

FIG. 8A is a longitudinal sectional view illustrating the support according to still another embodiment of the present invention, and FIG. 8B is a longitudinal sectional view illustrating a coupling relation of the support according to the still another embodiment of the present invention.

Referring to FIGS. 8A and 8B, a support 120′ according to the still another embodiment is not a ring shape that is as described above, and is formed in a “T”-shape. Accordingly, as illustrated in FIG. 8B, the silicone material that will be the fixing member 130 may be applied when the support 120′ is in a state in which the main lid 112 is fitted into the support 120′. As such, the support 120 may have various shapes, and it is self-evident that the fixing member 130 may also be modified in various shapes according to the shape of the support 120. Finally, in the present invention, a main feature is that the support 120 forms the through-hole 122 at the first side of the main lid 112 while the support 120 supports the main lid 112 no matter what shape the support 120 has. In addition, no matter what shape the fixing member 130 has, a type capable of fixing the support 120 for supporting the main lid 112 is sufficient.

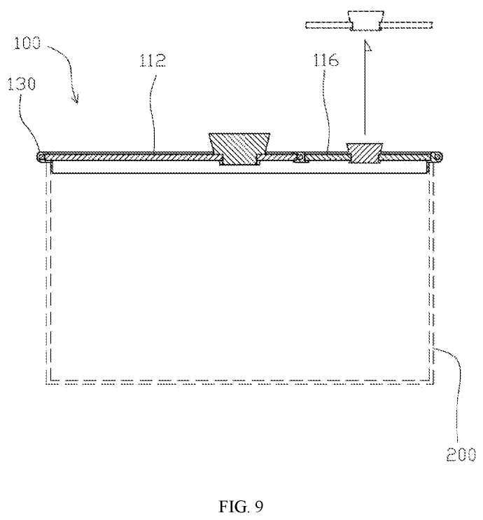

FIG. 9 is a longitudinal sectional view schematically illustrating an usage state of the cooking container lid according to an exemplary embodiment of the present invention.

Referring to FIG. 9, the cooking container lid 100 is used to seal an opening portion of a container 200, and an entire opening portion of the container 200 is opened when the main lid 112 is opened, and a part of the opening portion of the container 200 is opened when the auxiliary lid 116 is opened. This allows a user to easily add additional condiments, additional food materials, and so on by opening only the auxiliary lid 116 without opening the main lid 112, so that convenience of use is highly increased.

As a result, by proposing that the lid formed of the glass material is capable of being provided with the auxiliary lid 116 through the structural improvements, the present invention will lead to a further developed kitchen culture.

The foregoing description has described rather broadly the features and technical advantages of the present invention in order to allow the following claims of the invention to be better understood. Additional features and advantages that constitute the claims of the present invention will be described in detail below. It should be appreciated by those skilled in the art that the disclosed concepts and specific embodiments of the present invention may be used immediately as a basis for designing or modifying other structures to accomplish the invention and similar purposes.

Furthermore, the concepts and embodiments of the present invention disclosed herein may be used by those skilled in the art as a basis for modifying or designing other structures to accomplish the same purposes of the present invention, and such equivalent modifications or alterations may be made without departing from the spirit and scope of the present invention described in the attached claims.

### DESCRIPTION OF REFERENCE NUMERALS

100: cooking container lid

110: lid body

112: main lid

114: mounting hole

116: auxiliary lid

118: mounting hole

119: packing

120: support

122: through-hole

124: fastening hole

130: fixing member

140: seating jaw

200: container

A: handle

### INDUSTRIAL APPLICABILITY

The present invention relates to a cooking container lid having an auxiliary lid that is used in the cooking container, and is industrially applicable.

What is claimed is:

1. A cooking container lid having an auxiliary lid, comprising:
a lid body formed of a glass material and divided into a main lid and an auxiliary lid;
a support configured to support the main lid and forming a through-hole, wherein the through-hole is opened and closed by the auxiliary lid; and
a fixing member fixing the support to the main lid,
wherein an opening portion of the cooking container is entirely opened when the main lid is opened, and a part of the opening portion of the cooking container is opened when the auxiliary lid is opened.

2. The cooking container lid of claim 1, wherein each of the main lid and the auxiliary lid is provided with a mounting hole, wherein handle is allowed to be mounted in the mounting hole.

3. The cooking container lid of claim 1, wherein the fixing member is configured to surround both a border of the main lid and the support, wherein the main lid is securely supported.

4. The cooking container lid of claim 1, wherein an inner wall of the through-hole is provided with a seating jaw, wherein the seating jaw is configured to allow the auxiliary lid to be stably seated on the seating jaw and to increase a sealing capacity.

5. The cooking container lid of claim 1, wherein a border of the auxiliary lid is provided with a packing to increase a sealing capacity.
